(19) United States
(12) Patent Application Publication
(10) Pub. No.: US 2012/0217785 A1
(43) Pub. Date: Aug. 30, 2012

(54) FURNITURE ARTICLE WITH INTEGRATED PADDED SEAT, AND METHOD AND SYSTEM FOR MANUFACTURING SAME

(75) Inventor: Haim Nusbaher, Karmiel (IL)

(73) Assignee: Keter Plastic Ltd., Herzlia, IL (US)

(21) Appl. No.: 13/394,144

(22) PCT Filed: Sep. 7, 2010
(86) PCT No.: PCT/IB10/54031

§ 371 Date: May 10, 2012

Related U.S. Application Data
(60) Provisional application No. 61/240,251, filed on Sep. 7, 2009.

(51) Int. Cl. A47C 7/24; A47C 16/00; B29C 45/14

(52) U.S. Cl. 297/452.48; 264/274; 425/129.1; 297/461

(57) ABSTRACT

Furniture article with integrated padded seat, and method and system for manufacturing same. An apparatus comprises: a furniture article having integrated thereon a padded seat; wherein the furniture article is formed by injection molding of one or more raw plastic materials; wherein the padded seat is formed by injection molding of one or more raw plastic materials.

### FIELD

Some embodiments are related to the field of injection molding.

### BACKGROUND

Various types of furniture articles may be used for seating thereon. Such furniture articles may include, for example, chairs, seats, sofas, couches, benches. Some furniture articles may be formed of wood, rigid plastic, metal, or other generally rigid materials.

Various types of pillows and cushions may be used as intermediary layer between a person and a rigid surface of a furniture article. Such intermediary items are typically manufactured using a soft material, for example, sponge materials and/or woven textile.

Accordingly, a consumer may be required to purchase, and to maintain, two separate items: the rigid furniture article, and the soft intermediary layer. This may result in an increased cost for the consumer; an effort to purchase and maintain two items; the need to search for, and to purchase, an intermediary layer which needs to fit the shape and the dimensions of the furniture article; the risk that the intermediary layer may get lost or may fall down from the furniture article; and/or inconvenience due to the possible movement of the intermediary layer relative to the rigid furniture article.

### SUMMARY

Some embodiments include, for example, a furniture article with integrated padded seat, and system and method for manufacturing same.

In some embodiments, an apparatus comprises: a furniture article having integrated thereon a padded seat, wherein the furniture article is formed by injection molding of one or more raw plastic materials, wherein the padded seat is formed by injection molding of one or more raw plastic materials.

In some embodiments, the furniture article and the padded seat are formed substantially concurrently by a single process of injection molding of one or more raw plastic materials.

In some embodiments, the padded seat is formed separately from forming the furniture article, and wherein the padded seat is connected to the furniture article by mechanical connection.

In some embodiments, the padded seat is formed separately from forming the furniture article, and wherein the padded seat is connected to the furniture article by chemical connection.

In some embodiments, the padded seat is formed separately from forming the furniture article, and wherein the padded seat is connected to the furniture article by injection molding.

In some embodiments, the furniture article comprises an item selected from the group consisting of: a chair, a stool, a chest, a sofa, a couch, an indoor chair, an outdoor chair, an ottoman, a storage box, a pillow box.

In some embodiments, the one or more raw plastic materials comprise one or more materials selected from the group consisting of: polyurethane (PU), polypropylene (PP), thermoplastic elastomer (TPE), thermoplastic polymer, olephinic material, olefinic material.

In some embodiments, a method comprises: injection molding one or more raw plastic materials to form a furniture article having integrated thereon a padded seat.

In some embodiments, the method comprises: injection molding the one or more raw plastic materials to form said furniture article; placing a foam layer on said furniture article; injection molding the one or more raw plastic materials to form said padded seat integrated with said furniture article.

In some embodiments, placing a foam layer comprises: placing a masked foam layer on said furniture article.

In some embodiments, placing a foam layer comprises: masking said foam layer to prevent liquid injection molding material from entering pores of said foam.

In some embodiments, the method comprises: injection molding edges of said padded seat to weld said edges to said furniture article.

In some embodiments, the furniture article comprises an item selected from the group consisting of: a chair, a stool, a chest, a sofa, a couch, an indoor chair, an outdoor chair, an ottoman, a storage box, a pillow box.

In some embodiments, the one or more raw plastic materials comprise one or more materials selected from the group consisting of: polyurethane (PU), polypropylene (PP), thermoplastic elastomer (TPE), thermoplastic polymer, olephinic material, olefinic material.

In some embodiments, a system comprises: means for injection molding one or more raw plastic materials to form a furniture article having integrated thereon a padded seat.

In some embodiments, the system comprises: means for injection molding the one or more raw plastic materials to form said furniture article; means for placing a foam layer on said furniture article; means for injection molding the one or more raw plastic materials to form said padded seat integrated with said furniture article.

In some embodiments, the foam layer comprises a masked foam layer.

In some embodiments, the means for placing a foam layer comprises: means for masking said foam layer to prevent liquid injection molding material from entering pores of said foam.

In some embodiments, the system comprises: means for injection molding edges of said padded seat to weld said edges to said furniture article.

In some embodiments, the furniture article comprises an item selected from the group consisting of: a chair, a stool, a chest, a sofa, a couch, an indoor chair, an outdoor chair, an ottoman, a storage box, a pillow box.

In some embodiments, the one or more raw plastic materials comprise one or more materials selected from the group consisting of: polyurethane (PU), polypropylene (PP), thermoplastic elastomer (TPE), thermoplastic polymer, olephinic material, olefinic material.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic illustration of a furniture article, in accordance with some demonstrative embodiments.

FIG. 2 is a schematic illustration of a padded seat, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

The term “chair” as used herein includes, for example, various types of chairs, furniture articles, a bench, a stool, a sofa, a couch, an indoor chair or seat, an outdoor chair or seat, an arm-chair, a mono-block chair, a cushion box, an ottoman, a sun-tanning bath or bed, and/or various types of sitting devices or sitting constructs, and/or various types of devices or objects which may be used (among other purposes) for sitting thereon (e.g., a seat in a vehicle, a bus, a train, an airplane, a sledge, a stadium, a park, or the like). The term “chair” may further include, for example, any item which may be used to sit on (e.g., a chest or ottoman, a storage box, a pillow box) or leaned on or leaned against.

The term “padded seat” as used herein includes, for example, various types of padding, cushion, mattress-like or sponge-like layers, or other padding layer(s) or intermediate layers which provide a softness feeling to a person sitting on a rigid or semi-rigid chair.

Portions of the discussion herein may relate, for demonstrative purposes, to a chair having an integrated padded seat, wherein both the chair and the padded seat are formed by injection molding of raw plastic material(s). However, some embodiments may further include other items or articles which are not chairs, and which may include, similarly, an integrated padded seat or an integrated padded wall or cover or panel, wherein both the chair and the padded panel are formed by injection molding of raw plastic material; for example, a chest or a storage box.

Some embodiments may include a chair formed of plastic material(s) and/or formed utilizing injection molding, such that the chair has integrated therein a padded seat.

In some embodiments, the padded seat may be integral to the chair, such that the chair and the padded seat are formed using a single, common, production process, e.g., injection molding of one or more raw plastic materials.

In some embodiments, the chair and the padded seat are formed from the same material, or from the same sets of materials, or from similar sets of materials, or from sets of materials that share one or more common material(s) for both the chair and the padded seat. Such materials may include, for example, polyurethane (PU), polypropylene (PP), thermoplastic elastomer (TPE), thermoplastic polymer(s), olephinic materials or olefinic materials, or the like.

In some embodiments, the padded seat may be produces using injection molding, together with production of the chair, concurrently with or simultaneously with production of the chair, or shortly before or after production of the chair; and the padded seat need not be glued or bonded to the chair using a separate attachment step. In some embodiments, the padded seat may be glued or bonded to the chair using injection molding, during or shortly after the formation (by injection molding, too) of the chair and/or of the padded seat.

In some embodiments, the padded seat may be formed of polyurethane (PU) and/or foamed polyurethane and/or other types of suitable foamed material(s), which may injected directly upon a top surface or a sitting area of the chair after the chair is formed (e.g., using injection molding) and/or extracted from a production line or template or mold.

In some embodiments, the padded seat may be bonded, glued, or otherwise attached to the chair, optionally such that the attached padded seat is not detachable or not easily detachable.

In other embodiments, the produced padded seat may be glued, bonded, or otherwise attached or connected to the formed chair using other methods, for example, substantially immediately after the chair is formed (e.g., using injection molding) and/or extracted from a production line or template or mold.

Some embodiments may include a mono-block chair, or a cushion or pillow of a mono-block chair, having integrated therein a padded seat or a padded layer.

Some embodiments include a mono-block chair having an integral or integrated polyurethane pillow, cushion, or element.

In some embodiments, the chair and the padded seat may have the same color, or substantially the same color, or similar colors, or different colors.

In some embodiments, the chair may be substantially rigid or relatively rigid; whereas the padded seat may be substantially soft or relatively soft, or may be used as intermediary layer providing softness to a user.

In some embodiments, the padded seat may be injected directly onto the rigid chair, by utilizing a dedicated mold or template for the padded seat; thereby producing an integrated furniture article, in which the padded seat is connected to the rigid chair both chemically and mechanically.

In other embodiments, the padded seat may be formed separately by injection molding; and then, may be connected to the formed chair, for example, by mechanical connection and/or chemical connection, e.g., nails, gluing, bonding; or optionally, by injection molding of edges or corners of the padded seat to achieve a welding effect.

In some embodiments, an elastomer may be injected over a foam layer (e.g., PU foam) placed on the chair, in order to form the integrated chair with padded seat; or, the separately formed padded seat (e.g., by injection of elastomer over or around a foam layer) may then be connected to the rigid chair.

Some embodiments may include products which are formed, substantially exclusively, of injected materials and/or injection-based materials. Other embodiments may include products which are formed of a combination of injected materials and/or injection-based materials, together with other, non-injected materials, elements, or units. Such elements may include, for example, fabric, textile, woven materials, non-injected nonwoven materials (e.g., based on extrusion), padded constructive elements, padding elements, sponges, wood, metal(s), fibers, foams, stitched elements, elements which may provide softness and/or rigidness properties, elements which may provide coloring and/or imprinting, stitching lines, curvature-providing elements, supporting elements, or the like.

In some embodiments, utilization of injected materials or units, or injection-based materials or units, may provide durability and/or resistance to various environmental conditions, for example, weather conditions, rain, snow, wind, hail, moisture, humidity, sunshine, dryness, ultra-violet (UV) light or radiation, or the like. In some embodiments, the materials used may be materials which substantially do not absorb water or liquids, and/or materials which do not cause the user to sweat upon lengthy sitting thereon. In some embodiments, the materials used and/or the products produced may be, partially or entirely, water-resistant and/or may not soak water or liquid (e.g., in contrast with sponge or expanded polyurethane (PU)), non-aggregating and non-accumulating liquid drops (e.g., water drops, rain drops), liquid-resistant, fire-resistant, non-toxic upon burning, non-absorbing bad odors, stain-resistant, easy to clean, easy to wipe or dust, quick-drying, and/or wrinkle-free.

In some embodiments, an automated or semi-automated production line or production system may include one or more units of an injection molding system, for example, hopper, heater, reciprocating screw, mold, mold cavity, movable platen, barrel, nozzle, injection parts, clamping parts, or the like. Some embodiments may optionally include one or more units, systems, method and/or operations which may be used in, or in conjunction with: Co-injection (sandwich) molding; Fusible (lost, soluble) core injection molding; Gas-assisted injection molding; In-mold decoration and in mold lamination; Injection-compression molding; Insert and outsert molding; Lamellar (microlayer) injection molding; Low-pressure injection molding; Microinjection molding; Microcellular molding; Multicomponent injection molding (overmolding); Multiple live-feed injection molding; Powder injection molding; Push-Pull injection molding; Reaction injection molding; Resin transfer molding; Rheomolding; Structural foam injection molding; Structural reaction injection molding; Thin-wall molding; Vibration gas injection molding; Water assisted injection molding; Rubber injection; Injection molding of liquid silicone rubber; or the like.

Some embodiments may include systems and methods for manufacturing padding by utilizing injection molding of raw plastic material(s). For example, an injector or an extruder may inject (e.g., at high pressure) raw plastic material(s) into or onto or towards a template or mold, which may be formed of metal.

Some embodiments may utilize a first injection molding process to manufacture the padded seat; and a second (but temporally adjacent, in some embodiments) injection molding process to form the rigid chair or to form the connection between the padded seat and the rigid chair.

In some embodiments, double-injection-molding may be used in order to achieve stitching or welding between the padded seat and the rigid chair; or in order to form the padded seat by injection molding over or around a soft layer (e.g., foam or sponge or PU foam) placed on the rigid chair. In some embodiments, such sponge or foam may have a cover or a sealing or a mask, to ensure that liquid material which enters in the injection molding does not penetrate the pores or perforations of the sponge or foam. Such sealing or masking may include, for example, a micron sheet of Polysterene, or of other suitable plastic material which is not affected by heat. In some embodiments, the sponge itself may be self-sealing, for example, if a top layer in Polyurethane sponge is manufactured as a sealing layer in its production process; or by utilizing a chemical material which closes or seals the external pores of the sponge in order to block entrance of the hot, liquid material into the sponge. Such blocking or sealing may allow the sponge to retain its properties (e.g., its ability to compress and then expand back), even though the sponge is then used within an assembly that undergoes injection molding.

Upon placement of the sponge, the second injection molding may be performed. The raw plastic material, which is liquid and hot, may connect or bond to the edges of the previously-injected (previously-formed) member (e.g., the rigid chair). The process may cause the sponge to significantly compress (e.g., the compressed sponge may have a height of approximately 10 percent of its non-compressed height). After the second injection molding is complete, and the template or mold is opened, the sponge gradually decompresses and stretches back to its original height, thereby providing a pillow-like structure to the produced item. The gradual assumption of un-compressed state of the sponge is possible due to the utilization of flexible or elastic materials for the bottom member and/or the top member. Other suitable processes may be used.

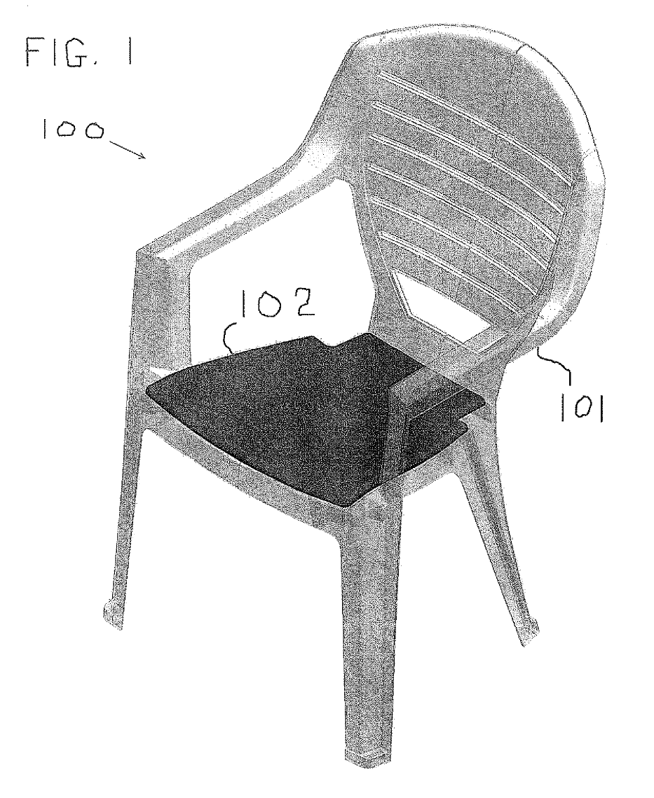

Reference is made to FIG. 1, which is a schematic illustration of a furniture article 100 in accordance with some demonstrative embodiments. Furniture article 100 may include, for example, a rigid chair 101 having integrated therein a padded seat 102. In some embodiments, the padded seat 102 may be irreversibly connected to the rigid chair 101, and may not be removed or detached from the rigid chair 101.

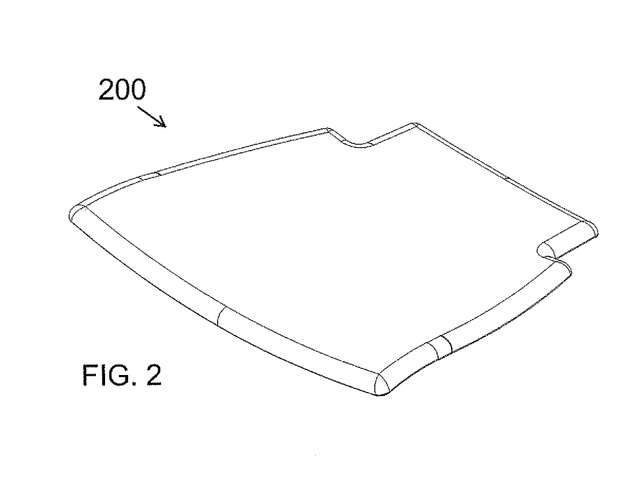

Reference is made to FIG. 2, which is a schematic illustration of a padded seat 200 in accordance with some demonstrative embodiments. Padded seat 200 may be manufactured separately from a furniture article or from a rigid chair, and then may be welded or connected to such furniture article or rigid chair through injection molding. In other embodiments, padded seat 200 may be manufactured in the same injection molding process used for manufacturing the rigid chair.

In some embodiments, an upper layer or a cover or an external layer of the padded seat may be formed to have one or more of a variety of textures; for example, a fabric-like texture, a Rattan-like texture, a metal-like or wood-like texture, or the like; and may have one or more colors.

For demonstrative purposes, a mono-block chair is shown; however, some embodiments may be utilized in conjunction with other types of chairs, sofa, couch, arm-chair, sun-tanning bed, stool, pool chair, beach chair, folding chair, and other suitable furniture articles.

The terms “plurality” or “a plurality” as used herein include, for example, “multiple” or “two or more”. For example, “a plurality of items” includes two or more items.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments have been illustrated and described herein, many modifications, substitutions, changes, and equivalents may occur to those skilled in the art. Accordingly, the following claims are intended to cover all such modifications, substitutions, changes, and equivalents.

What is claimed is:

1. An apparatus comprising:
a furniture article having integrated thereon a padded seat,
wherein the furniture article is formed by injection molding of one or more raw plastic materials,
wherein the padded seat is formed by injection molding of one or more raw plastic materials.

2. The apparatus of claim 1, wherein the furniture article and the padded seat are formed substantially concurrently by a single process of injection molding of one or more raw plastic materials.

3. The apparatus of claim 1, wherein the padded seat is formed separately from forming the furniture article, and wherein the padded seat is connected to the furniture article by mechanical connection.

4. The apparatus of claim 1, wherein the padded seat is formed separately from forming the furniture article, and wherein the padded seat is connected to the furniture article by chemical connection.

5. The apparatus of claim 1, wherein the padded seat is formed separately from forming the furniture article, and wherein the padded seat is connected to the furniture article by injection molding.

6. The apparatus of claim 1, wherein the furniture article comprises an item selected from the group consisting of: a chair, a stool, a chest, a sofa, a couch, an indoor chair, an outdoor chair, an ottoman, a storage box, a pillow box.

7. The apparatus of claim 1, wherein the one or more raw plastic materials comprise one or more materials selected from the group consisting of: polyurethane (PU), polypropylene (PP), thermoplastic elastomer (TPE), thermoplastic polymer, olephinic material, olefinic material.

8. A method comprising:
injection molding one or more raw plastic materials to form a furniture article having integrated thereon a padded seat.

9. The method of claim 8, comprising:
injection molding the one or more raw plastic materials to form said furniture article;
placing a foam layer on said furniture article;
injection molding the one or more raw plastic materials to form said padded seat integrated with said furniture article.

10. The method of claim 9, wherein placing a foam layer comprises:
placing a masked foam layer on said furniture article.

11. The method of claim 9, wherein placing a foam layer comprises:
masking said foam layer to prevent liquid injection molding material from entering pores of said foam.

12. The method of claim 9, comprising:
injection molding edges of said padded seat to weld said edges to said furniture article.

13. The method of claim 8, wherein the furniture article comprises an item selected from the group consisting of: a chair, a stool, a chest, a sofa, a couch, an indoor chair, an outdoor chair, an ottoman, a storage box, a pillow box.

14. The method of claim 8, wherein the one or more raw plastic materials comprise one or more materials selected from the group consisting of: polyurethane (PU), polypropylene (PP), thermoplastic elastomer (TPE), thermoplastic polymer, olephinic material, olefinic material.

15. A system comprising:
means for injection molding one or more raw plastic materials to form a furniture article having integrated thereon a padded seat.

16. The system of claim 15, comprising:
means for injection molding the one or more raw plastic materials to form said furniture article;
means for placing a foam layer on said furniture article;
means for injection molding the one or more raw plastic materials to form said padded seat integrated with said furniture article.

17. The system of claim 16, wherein the foam layer comprises a masked foam layer.

18. The system of claim 16, wherein the means for placing a foam layer comprises:
means for masking said foam layer to prevent liquid injection molding material from entering pores of said foam.

19. The system of claim 16, comprising:
means for injection molding edges of said padded seat to weld said edges to said furniture article.

20. The system of claim 15, wherein the furniture article comprises an item selected from the group consisting of: a chair, a stool, a chest, a sofa, a couch, an indoor chair, an outdoor chair, an ottoman, a storage box, a pillow box.

21. The system of claim 15, wherein the one or more raw plastic materials comprise one or more materials selected from the group consisting of: polyurethane (PU), polypropylene (PP), thermoplastic elastomer (TPE), thermoplastic polymer, olephinic material, olefinic material.
